(19) United States
(12) Patent Application Publication
(10) Pub. No.: US 2026/0301657 A1
(43) Pub. Date: Oct. 1, 2026

(54) ELECTRONIC DEVICE

(71) Applicant: Innolux Corporation, Miaoli County (TW)

(72) Inventor: Ching-Wen Shih, Miaoli County (TW)

(73) Assignee: Innolux Corporation, Miaoli County (TW)

(21) Appl. No.: 19/568,812

(22) Filed: Mar. 17, 2026

(30) Foreign Application Priority Data
Mar. 28, 2025 (TW) 114112020

(51) Int. Cl. G09G 3/32

(52) U.S. Cl. CPC G09G 3/32; G09G 2310/0267; G09G 2310/0289; G09G 2310/08

(57) ABSTRACT

An electronic device includes a display panel, a gate driver circuit, a control element, a first signal line, and a second signal line. The display panel includes a gate line. The gate driver circuit is electrically connected to the gate line. The control element provides a plurality of frame start signals within a plurality of frame times. In a first time period, the control element provides a first voltage to the first signal line and provides a second voltage to the second signal line. In a second time period, the control element provides the first voltage to the second signal line and provides the second voltage to the first signal line. The first time period and the second time period are respectively greater than two frame times.

### CROSS-REFERENCE TO RELATED APPLICATION

This application claims the priority benefit of Taiwan application serial no. 114112020, filed on Mar. 28, 2025. The entirety of the above-mentioned patent application is hereby incorporated by reference herein and made a part of this specification.

### BACKGROUND

### Technical Field

The disclosure relates to a device, and particularly to an electronic device.

### Related Art

The electronic device may include a display panel, a gate driver circuit, and a control element. The control element includes a timing controller and a level shifter. The gate driver circuit may provide a plurality of gate signals to a plurality of gate lines in the display panel at different time points. For a gate line, it is necessary to maintain a low level for most of the time. Generally, between the current timing controller and the level shifter, two connection lines need to be set up to transmit a first signal and a second signal of different polarities to the level shifter, so that two transistors in the gate driver circuit are turned on alternately, making the corresponding gate maintain a low level. Therefore, the two connection lines increase the area of the control element.

### SUMMARY

The disclosure provides an electronic device. The area of the control element of the electronic device can be reduced.

In an embodiment of the disclosure, the electronic device of the disclosure includes a display panel, a gate driver circuit, a control element, a first signal line, and a second signal line. The display panel includes a substrate, a plurality of gate lines, and a plurality of pixel units. The plurality of gate lines are disposed on the substrate. The plurality of pixel units are disposed on the substrate. The plurality of gate lines are electrically connected to the plurality of pixel units respectively. The display panel displays within plurality of frame times. The gate driver circuit is electrically connected to the plurality of gate lines. The control element provides a plurality of frame start signals within the plurality of frame times. The first signal line is electrically connected between the control element and the gate driver circuit. The second signal line is electrically connected between the control element and the gate driver circuit. In a first time period, the control element provides a first voltage to the first signal line and provides a second voltage to the second signal line, and the first time period is greater than two frame times. The first voltage is higher than the second voltage. In a second time period, the control element provides the first voltage to the second signal line and provides the second voltage to the first signal line, and the second time period is greater than two frame times.

Based on the above, the control element generates high voltage and low voltage according to the frame start signal. In the first time period, the control element provides the high voltage to the first signal line and provides the low voltage to the second signal line. In the second time period, the control element provides the high voltage to the second signal line and provides the low voltage to the first signal line. Therefore, the first voltage signal located on the first signal line is inverted relative to the second voltage signal located on the second signal line. It should be noted that the control element generates the high voltage and the low voltage according to the frame start signals. That is, the control element may generate the first voltage signal and the second voltage signal according to the frame start signals. Compared with the related art, the control element does not need to receive the first signal and the second signal. The control element also does not need two additional connection lines to transmit the first signal and the second signal. In this way, the area of the control element can be reduced.

### BRIEF DESCRIPTION OF THE DRAWINGS

FIG. 1 is a schematic diagram of an electronic device according to an embodiment of the disclosure.

FIG. 2 is a schematic diagram of the electronic device according to an embodiment of the disclosure.

FIG. 3 is a schematic diagram of the electronic device according to an embodiment of the disclosure.

FIGS. 4A and 4B are timing diagrams according to an embodiment of the disclosure.

FIG. 5 is a schematic diagram of a level shifter and a storage unit according to an embodiment of the disclosure.

FIG. 6 is a schematic diagram of a gate driver unit according to an embodiment of the disclosure.

### DESCRIPTION OF THE EMBODIMENTS

The disclosure may be understood through the following detailed description in conjunction with the drawings as described below. It should be noted that, for the purpose of clear explanation and easy understanding by the reader, each drawing of the disclosure illustrates a portion of the electronic device, and some components in each drawing may not be drawn to scale. Furthermore, the number and dimensions of each device shown in the drawings are illustrative only and are not intended to limit the scope of the disclosure.

Certain terms are used throughout the description and the following claims to refer to particular components. As persons skilled in the art will understand, electronic device manufacturers may refer to components by different names. This document does not intend to distinguish between components that differ in name but have the same function. In the following description and in the claims, the terms "comprise," "include," and "have" are used in an open-ended manner, and thus should be interpreted to mean "including, but not limited to. ....." Therefore, when the terms "comprise," "include," and/or "have" are used in the description of this disclosure, the terms will indicate the presence of corresponding features, regions, steps, operations, and/or components, but are not limited to the presence of one or more corresponding features, regions, steps, operations, and/or components.

It should be understood that when an element is referred to as being "coupled to," "connected to," or "turned on to" another element, the element may be directly connected to the other element and may directly establish an electrical connection, or there may be intermediate elements between these elements for relaying electrical connections (indirect electrical connections). In contrast, when an element is referred to as being "directly coupled to," "directly turned on to," or "directly connected to" another element, no intermediate elements exist.

Although terms such as first, second, and third may be used to describe various components, such components are not limited by the terms. The terms are merely used to distinguish one component from other components in the specification. The claims may not use the same terms, but may use terms such as first, second, third with respect to the order in which elements are claimed. Therefore, in the following description, a first component may be a second component in the claims.

The electronic device of this disclosure may include a display device, an antenna device, a sensing device, a light-emitting device, a touch electronic device, a curved electronic device, or a free shape electronic device, but the disclosure is not limited thereto. The electronic device may include a foldable or flexible electronic device. The electronic device may include, for example, liquid crystal, light-emitting diode, Quantum dot (QD), fluorescence, phosphor, other suitable display media, or combinations of the above materials, but the disclosure is not limited thereto. The light-emitting diode may include, for example, organic light emitting diode (OLED), mini LED, micro LED, or quantum dot LED (QDLED), or other suitable materials, or combinations thereof, but the disclosure is not limited thereto. The display device may include, for example, a joined display device, but the disclosure is not limited thereto. The antenna device may be, for example, a liquid crystal antenna, but the disclosure is not limited thereto. The antenna device may include, for example, an antenna joined device, but the disclosure is not limited thereto. It should be noted that the electronic device may be any arrangement or combination of the aforementioned, but the disclosure is not limited thereto. In addition, the shape of the electronic device may be rectangular, circular, polygonal, a shape with curved edges, or other suitable shapes. The electronic device may have peripheral systems such as a driving system, a control system, or a light source system to support the display device, the antenna device, or the joined device, but the disclosure is not limited thereto. The sensing device may include a camera or an infrared sensor, or a fingerprint sensor, but the disclosure is not limited thereto. In some embodiments, the sensing device may further include a flash, an infrared (IR) light source, other sensors, electronic components, or combinations thereof, but the disclosure is not limited thereto.

In this disclosure, embodiments use "pixel" or "pixel unit" as a unit for describing a specific area containing at least one functional circuit for at least one specific function. The area of a "pixel" depends on the unit used to provide a specific function, and adjacent pixels may share the same parts or lines, but may further include their own specific parts therein. For example, adjacent pixels may share the same scan line or the same data line, but a pixel may further include at least one of its own transistor, capacitor, and at least one light-emitting diode.

It should be noted that the technical features in the different embodiments described below may be substituted, recombined, or mixed with each other to form another embodiment without departing from the spirit of the disclosure.

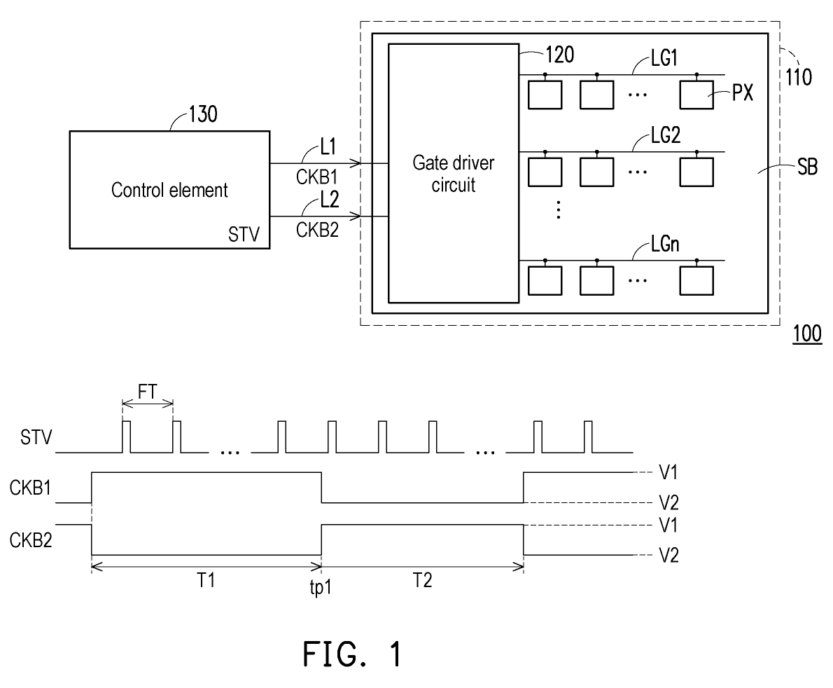

Please refer to FIG. 1, which is a schematic diagram of an electronic device according to an embodiment of this disclosure. In this embodiment, an electronic device 100 includes a display panel 110, a gate driver circuit 120, a control element 130, a first signal line L1, and a second signal line L2. The display panel 110 includes a substrate SB, gate lines LG1 to LGn, and a plurality of pixel units PX. The gate lines LG1 to LGn are disposed on the substrate SB. The plurality of pixel units PX are disposed on the substrate SB. The gate lines LG1 to LGn are respectively electrically connected to the plurality of pixel units PX. The gate driver circuit 120 is electrically connected to at least one of the plurality of pixel units PX. For example, the gate driver circuit 120 is electrically connected to the plurality of pixel units PX in a first pixel row via the gate line LG1.

In this embodiment, the control element 130 provides a frame start signal STV in each frame time FT, and generates a high voltage V1 (that is, a first voltage) and a low voltage V2 (that is, a second voltage) according to the frame start signal STV. The first signal line L1 is electrically connected between the control element 130 and the gate driver circuit 120. The first signal line L1 transmits a voltage signal CKB1. The second signal line L2 is electrically connected between the control element 130 and the gate driver circuit 120. The second signal line L2 transmits a voltage signal CKB2. The gate driver circuit 120 respectively receives the voltage signals CKB1, CKB2. The gate driver circuit 120 may operate based on the voltage signals CKB1, CKB2. For example, the gate driver circuit 120 may suppress noise interference based on the voltage signals CKB1, CKB2.

In a first time period T1, the control element 130 is configured to provide the first voltage V1 to the first signal line L1, and provide the second voltage V2 to the second signal line L2. The first voltage is greater than the second voltage. In this disclosure, for convenience of explanation, the first voltage may be referred to as a high voltage, and the second voltage may be referred to as a low voltage. In a second time period T2, the control element 130 provides the high voltage V1 to the second signal line L2, and provides the low voltage V2 to the first signal line L1. In this embodiment, the first time period T1 and the second time period T2 are respectively greater than two frame times FT. For example, time durations of the first time period T1 and the second time period T2 are respectively greater than two frame times FT and less than or equal to 1000 frame times FT. According to some embodiments, the time durations of the first time period T1 and the second time period T2 are respectively greater than or equal to 10 frame times FT and less than or equal to 500 frame times FT. According to some embodiments, the time durations of the first time period T1 and the second time period T2 are respectively greater than or equal to 20 frame times FT and less than or equal to 100 frame times FT. The time durations of the first time period T1 and the second time period T2 may be equal or unequal.

It is worth mentioning here that the control element 130 generates the high voltage V1 and the low voltage V2 according to the frame start signal STV. Therefore, the voltage signal CKB1 located on the first signal line L1 is inverted relative to the voltage signal CKB2 located on the second signal line L2. It should be noted that the control element 130 generates the high voltage V1 and the low voltage V2 according to the frame start signal STV.

In the related art, in addition to the first signal line and the second signal line, the level shifter of the existing control element needs to transmit the first signal and the second signal through two additional connection lines to receive the first signal and the second signal, and generate the voltage signals CKB1, CKB2 according to the first signal and the second signal. Compared with the related art, according to some embodiments of the disclosure, the control element 130 may generate the voltage signals CKB1, CKB2 according to the frame start signal STV. The control element 130 does not need independent first signal and second signal. The control element 130 does not need two additional connection lines to transmit the first signal and the second signal, either. In this way, the area of the control element 130 can be reduced.

In this embodiment, the gate driver circuit 120 may be disposed on the substrate SB. In some embodiments, the gate driver circuit 120 is disposed outside the substrate SB. The gate driver circuit 120 may be correspondingly connected to the gate lines LG1 to LGn through a connection structure or any form of chip on film (COF) packaging method.

In this embodiment, the gate driver circuit 120 provides gate signals to the gate lines LG1 to LGn. Therefore, a plurality of pixel rows may be scanned sequentially.

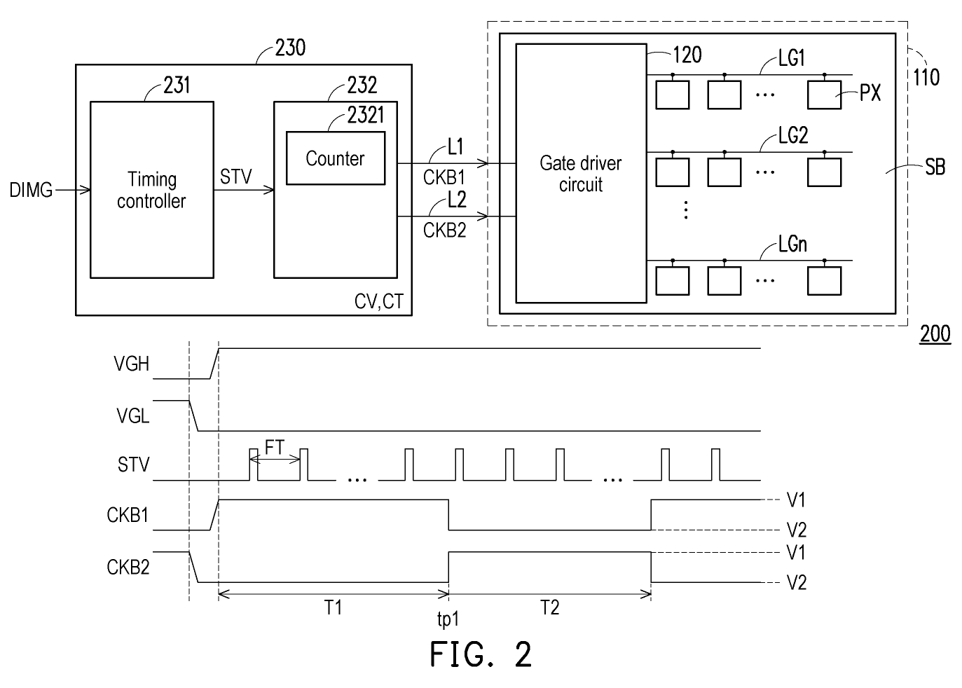

Please refer to FIGS. 1 and 2. FIG. 2 is a schematic diagram of the electronic device according to an embodiment of this disclosure. In this embodiment, an electronic device 200 includes a display panel 110, a gate driver circuit 120, a control element 230, a first signal line L1, and a second signal line L2. The connections and operations of the display panel 110, the gate driver circuit 120, the first signal line L1, and the second signal line L2 have been clearly described in the embodiment of FIG. 1, so details will not be repeated here.

In this embodiment, the control element 230 includes a timing controller 231 and a level shifter 232. The timing controller 231 is configured to provide a plurality of frame start signals STV. The timing controller 231 may provide the frame start signal STV according to image data DIMG, for example. The level shifter 232 is electrically connected to the timing controller 231, the first signal line L1, and the second signal line L2. The level shifter 232 receives the plurality of frame start signals STV, and provides the high voltage V1 and the low voltage V2 according to the frame start signal STV. In other words, the level shifter 232 may generate the voltage signals CKB1, CKB2 according to the frame start signal STV. In the first time period T1, the voltage value of the voltage signal CKB1 is the high voltage V1. The voltage value of the voltage signal CKB2 is the low voltage V2. In the second time period T2, the voltage value of the voltage signal CKB1 is the low voltage V2. The voltage value of the voltage signal CKB2 is the high voltage V1.

Furthermore, the level shifter 232 may initiate a transition from the first time period T1 to the second time period T2 or initiate a transition from the second time period T2 to the first time period T1 according to the number of times the frame start signal STV is received.

In this embodiment, the level shifter 232 includes a counter 2321. The counter 2321 is configured to receive the plurality of frame start signals STV and count the number of pulses of the frame start signal STV to generate a count value CV. The level shifter 232 receives the count value CV. When the count value CV reaches a count setting value CT, the level shifter 232 is configured to initiate a transition from the first time period T1 to the second time period T2 or to initiate a transition from the second time period T2 to the first time period T1.

When the electronic device 200 is powered on, the electronic device 200 generates a reference low voltage VGL and a reference high voltage VGH. In this embodiment, the reference low voltage VGL is a reference voltage. Therefore, the generation time of the reference low voltage VGL is earlier than the generation time of the reference high voltage VGH. The level shifter 232 may first generate the low voltage V2 according to the reference low voltage VGL and generate the voltage signal CKB2. The level shifter 232 may generate the high voltage V1 according to the reference high voltage VGH and generate the voltage signal CKB1.

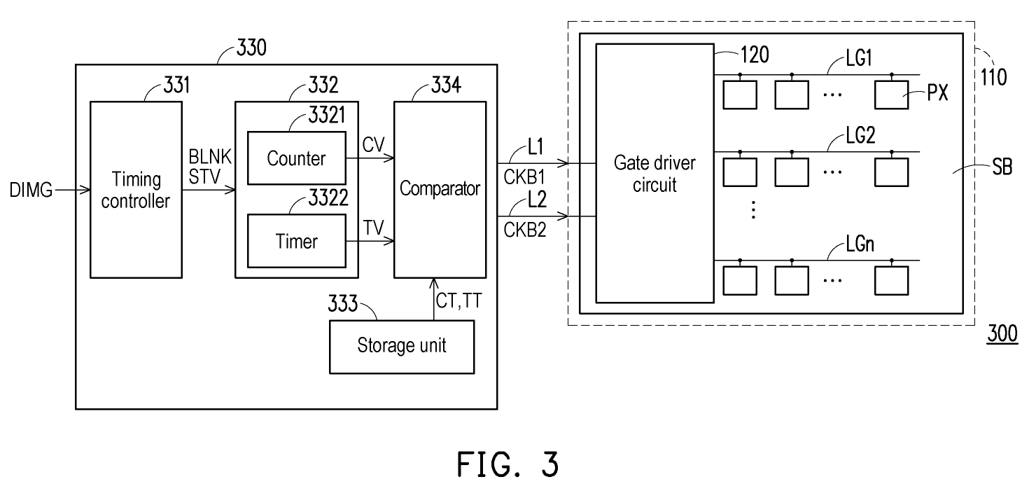

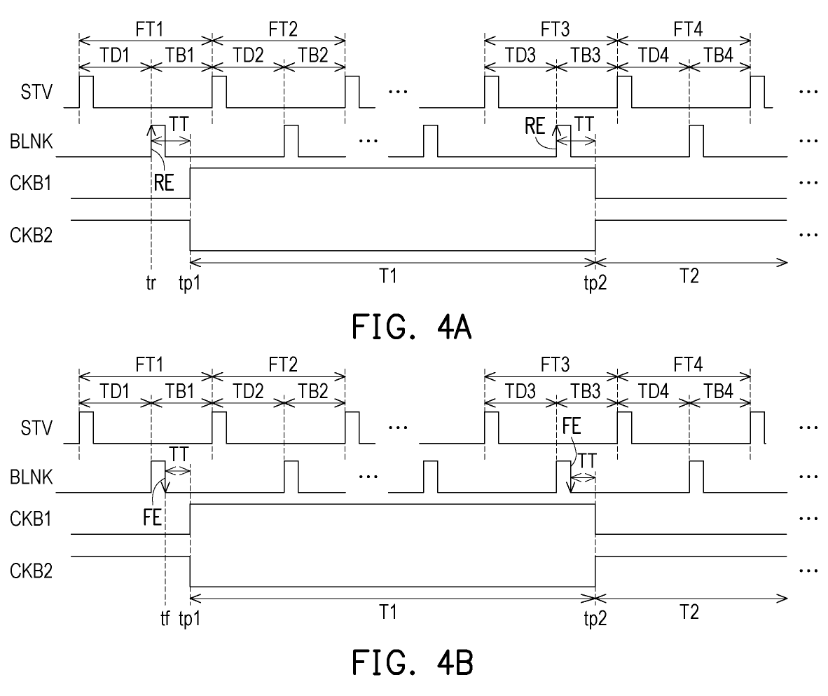

Please refer to FIGS. 3 and 4A. FIG. 3 is a schematic diagram of the electronic device according to an embodiment of this disclosure. FIG. 4A is a timing diagram according to an embodiment of this disclosure. In this embodiment, an electronic device 300 includes a display panel 110, a gate driver circuit 120, a control element 330, a first signal line L1, and a second signal line L2. The connections and operations of the display panel 110, the first signal line L1, and the second signal line L2 have been clearly described in the embodiment of FIG. 1, so details will not be repeated here.

As shown in FIG. 3, in this embodiment, the control element 330 includes a timing controller 331 and a level shifter 332, a storage unit 333, and a comparator unit 334. The storage unit 333 is configured to store the count setting value CT. The comparator unit 334 is configured to compare the count value CV and the count setting value CT. When the count value CV matches the count setting value CT, the level shifter 332 initiates a transition between the first time period T1 and the second time period T2 at a switching time point tp1. For example, when the count value CV equals the count setting value CT, the level shifter 332 initiates a transition between the first time period T1 and the second time period T2 at the switching time point tp1. In addition, when the count value CV matches the count setting value CT, the comparator unit 334 further compares a timer value TV and a time setting value TT. When the timer value TV matches the time setting value TT, the level shifter 332 initiates a transition between the first time period T1 and the second time period T2 at the switching time point tp1. In this embodiment, the comparator unit 334 may be located outside the level shifter 332. In some embodiments, the comparator unit 334 may be located inside the level shifter 332.

In this embodiment, FIG. 4A shows a first frame time FT1, a second frame time FT2, a third frame time FT3, and a fourth frame time FT4. The first frame time FT1 is adjacent to the second frame time FT2. The first frame time FT1 includes a display period TD1 and a blanking period TB1. The second frame time FT2 includes a display period TD2 and a blanking period TB2. The blanking period TB1 is between the display period TD1 and the display period TD2. The third frame time FT3 is adjacent to the fourth frame time FT4. The third frame time FT3 includes a display period TD3 and a blanking period TB3. The fourth frame time FT4 includes a display period TD4 and a blanking period TB4. The blanking period TB3 is between the display period TD3 and the display period TD4. The control element 330 includes a timing controller 331, a level shifter 332, and a storage unit 333. The timing controller 331 is configured to provide a blanking signal BLNK within the blanking period TB1. The blanking period TB1 includes the switching time point tp1. The timing controller 331 provides the blanking signal BLNK during the blanking period TB3. The blanking period TB3 includes a switching time point tp2. The storage unit 333 stores the count setting value CT and the time setting value TT. The timing controller 331 provides the frame start signal STV and the blanking signal BLNK. The level shifter 332 receives the blanking signal BLNK and the frame start signal STV. The level shifter 332 includes a counter 3321 and a timer 3322.

As shown in FIG. 4A, according to some embodiments, specifically, the timer 3322 may generate the switching time point tp1 based on a time point tr of the start of the pulse of the blanking signal BLNK plus the time setting value TT. The timer 3322 may generate the switching time point tp2 based on the time point tr of the start of the pulse of the blanking signal BLNK plus the time setting value TT. The counter 3321 receives the frame start signal STV and counts the number of pulses of the frame start signal STV to generate the count value CV. When the count value CV reaches the count setting value CT, the level shifter 332 starts timing based on the time point when the pulse of the blanking signal BLNK starts to generate the timer value TV, and determines the switching time points tp1, tp2 based on the timer value TV.

In this embodiment, the level shifter 332 further includes the timer 3322. When the count value CV reaches the count setting value CT, the timer 3322 starts timing at the time point tr of a rising edge RE of the pulse of the blanking signal BLNK to generate the timer value TV. When the timer value TV reaches the time setting value TT, the level shifter 332 determines the switching time points tp1, tp2 based on the timer value TV.

In this embodiment, the time setting value TT is shorter than a time duration between the rising edge RE of the blanking signal BLNK and the rising edge of the first frame start signal STV in the display period TD. Therefore, the switching time points tp1, tp2 of the polarity of the voltage signal CKB1 and the polarity of the voltage signal CKB2 may be determined within the corresponding blanking periods TB1, TB3. In other words, when the count value CV reaches the count setting value CT, the switching time points tp1, tp2 are delayed to the corresponding blanking periods TB1, TB3 respectively.

Please refer to FIGS. 3 and 4B. FIG. 4B is a timing diagram drawn according to an embodiment of the disclosure. In this embodiment, the timer 3322 may generate the switching time point tp1 based on a time point tf of the end of the pulse of the blanking signal BLNK plus the time setting value TT. The timer 3322 may generate the switching time point tp2 based on the time point tf of the end of the pulse of the blanking signal BLNK plus the time setting value TT. The timer 3322 starts timing at the time point of a falling edge FE of the pulse of the blanking signal BLNK to generate the timer value TV. When the timer value TV reaches the time setting value TT, the level shifter 332 determines the switching time points tp1, tp2 based on the timer value TV. In this embodiment, the time setting value TT is shorter than a time duration between the falling edge FE of the blanking signal BLNK and the rising edge of the first frame start signal STV in the display period TD. Therefore, the switching time points tp1, tp2 of the polarity of the voltage signal CKB1 and the polarity of the voltage signal CKB2 may be determined within the blanking period TB. In other words, when the count value CV reaches the count setting value CT, the switching time points tp1, tp2 are delayed to the blanking period TB respectively.

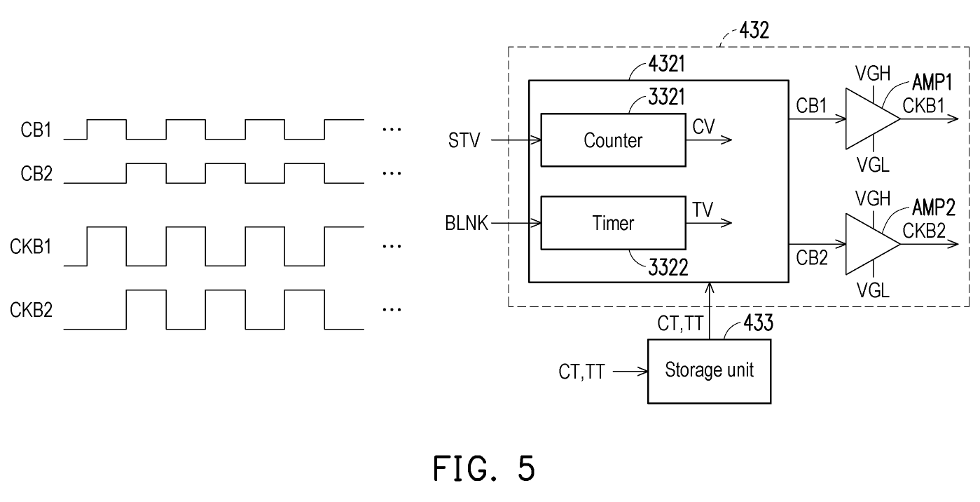

Please refer to FIGS. 1 and 5. FIG. 5 is a schematic diagram of a level shifter and a storage unit drawn according to an embodiment of the disclosure. In this embodiment, the level shifter 432 includes a signal generator 4321 and amplifiers AMP1, AMP2.

The signal generator 4321 includes the counter 3321 and the timer 3322. The implementation methods of the counter 3321 and the timer 3322 have been clearly described in the embodiment of FIG. 3, so details will not be repeated here.

The storage unit 433 stores the count setting value CT and the time setting value TT. In this embodiment, the storage unit 433 may receive the count setting value CT and the time setting value TT from an external circuit through a transmission interface. The transmission interface may be, for example, an I2C interface (but the disclosure is not limited thereto). Therefore, users may modify the count setting value CT and the time setting value TT stored in the storage unit 433 using the external circuit.

The signal generator 4321 may generate a first signal CB1 and a second signal CB2. The signal generator 4321 may read the count setting value CT and the time setting value TT stored in the storage unit 433. The voltage value of the first signal CB1 in the first time period T1 is a first voltage value. The voltage value of the second signal CB2 in the first time period T1 is a second voltage value. The first voltage value is higher than the second voltage value. The voltage value of the first signal CB1 in the second time period T2 is the second voltage value. The voltage value of the second signal CB2 in the second time period T2 is the first voltage value.

The signal generator 4321 receives the count value CV and the timer value TV. When the count value CV reaches the count setting value CT, the signal generator 4321 starts timing based on the pulse of the blanking signal BLNK to generate the timer value TV, and determines the switching time point of the first time period T1 and the second time period T2 according to the timer value TV.

In addition, the amplifier AMP1 amplifies the first signal CB1 to generate the voltage signal CKB1. The amplifier AMP2 amplifies the second signal CB2 to generate the voltage signal CKB2. The amplifiers AMP1, AMP2 may convert the first voltage value to the high voltage V1, and convert the second voltage value to the low voltage V2. The high voltage V1 is higher than the first voltage value. The low voltage V2 is lower than the second voltage value. In this embodiment, the voltage value of the high voltage V1 is substantially equal to the voltage value of the reference high voltage VGH. The voltage value of the low voltage V2 is substantially equal to the voltage value of the reference low voltage VGL.

In some embodiments, the level shifter 332 may further generate a plurality of clock signals, and provide the frame start signal STV and the plurality of clock signals to the gate driver circuit 120. For example, the level shifter 332 may receive a modulation signal, and demodulate the modulation signal to generate the plurality of clock signals.

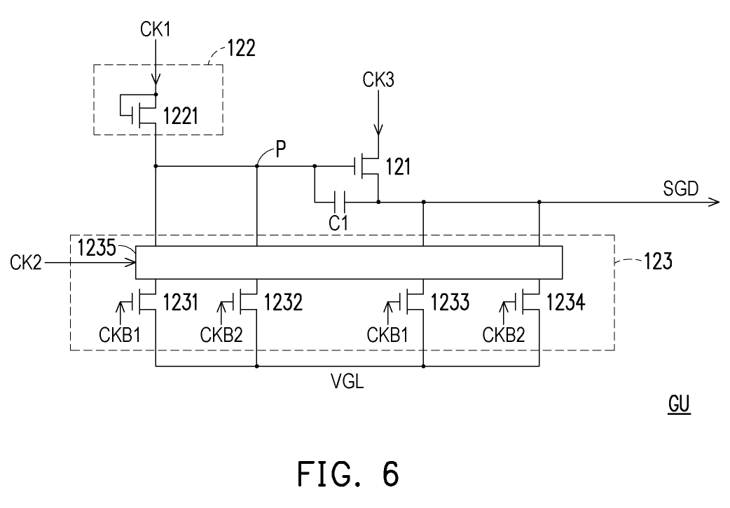

Please refer to FIGS. 1 and 6 and . FIG. 6 is a schematic diagram of a gate driver unit according to an embodiment of the disclosure. In this embodiment, the gate driver circuit 120 includes a gate driver unit GU. The gate driver unit GU may be one of a plurality of stages of gate driver units of the gate driver circuit 120. The gate driver unit GU may be selected based on the pulse of the clock signal CK1, and provide a gate drive signal SDG according to the pulse of a clock signal CK3. At least one of the gate lines LG1 to LGn may receive the gate drive signal SDG. After the gate driver unit GU outputs the pulse of the gate drive signal SDG, the gate driver unit GU may pull down the voltage at the gate driver unit GU using the voltage signals CKB1, CKB2. The display panel 110 includes plurality of pixel rows. The gate driver unit GU may scan (or select) the corresponding pixel row according to the pulse of the gate drive signal SDG. For example, the display panel 110 includes 100 pixel rows. The gate driver unit GU scans a single pixel row using the pulse of the gate drive signal SDG during a scanning period. Therefore, the scanning period of the gate driver unit GU is very short. In the frame time FT, the gate driver unit GU does not provide the pulse of the gate drive signal SDG during a non-scanning period outside the scanning period. During the non-scanning period, the voltage value of the gate drive signal SDG is a low voltage value. It should be noted that once the gate driver unit GU provides an abnormal pulse or noise during the non-scanning period, the gate driver unit GU causes the next stage gate driver unit to malfunction. Therefore, during the non-scanning period, it is necessary for the voltage value of the gate drive signal SDG to be pulled down to a low voltage value.

In this embodiment, the gate driver circuit 120 includes an output transistor 121, a capacitor C1, a pull-up circuit 122, and a pull-down circuit 123. A first terminal of the output transistor 121 receives the clock signal CK3. A second terminal of the output transistor 121 outputs the gate drive signal SDG. The capacitor C1 is electrically connected between the second terminal of the output transistor 121 and the control terminal (that is, a node P) of the output transistor 121. The pull-up circuit 122 is electrically connected to the control terminal of the output transistor 121. The pull-up circuit 122 pulls up the voltage value at the control terminal of the output transistor 121. The pull-up circuit 122 pulls up the voltage value at the node P according to the clock signal CK1. The pull-down circuit 123 is electrically connected to the control terminal of the output transistor 121. The pull-down circuit 123 pulls down the voltage value at the control terminal of the node P. In addition, the pull-down circuit 123 is electrically connected to the second terminal of the output transistor 121. According to some embodiments, the pull-down circuit 123 pulls down the voltage value at the second terminal of the output transistor 121. According to some embodiments, the pull-down circuit 123 pulls down the voltage value at the control terminal of the output transistor 121.

The pull-down circuit 123 includes a first pull-down transistor 1231 and a second pull-down transistor 1232. The first pull-down transistor 1231 and the second pull-down transistor 1232 are electrically connected to the control terminal of the output transistor 121. The first pull-down transistor 1231 pulls down the voltage value at the control terminal of the output transistor 121 according to the voltage signal CKB1 at the first signal line L1. The second pull-down transistor 1232 pulls down the voltage value at the control terminal of the output transistor 121 according to the voltage signal CKB2 at the second signal line L2. The control terminal of the first pull-down transistor 1231 receives the voltage signal CKB1. The second terminal of the first pull-down transistor 1231 receives the reference low voltage VGL. The control terminal of the second pull-down transistor 1232 receives the voltage signal CKB2. The second terminal of the second pull-down transistor 1232 receives the reference low voltage VGL.

The pull-down circuit 123 further includes a third pull-down transistor 1233 and a fourth pull-down transistor 1234. The third pull-down transistor 1233 and the fourth pull-down transistor 1234 are electrically connected to the second terminal of the output transistor 121. The third pull-down transistor 1233 pulls down the voltage value at the second terminal of the output transistor 121 according to the voltage signal CKB1 at the first signal line L1. The fourth pull-down transistor 1234 pulls down the voltage value at the second terminal of the output transistor 121 according to the voltage signal CKB2 at the second signal line L2. The control terminal of the third pull-down transistor 1233 receives the voltage signal CKB1. The second terminal of the third pull-down transistor 1233 receives the reference low voltage VGL. The control terminal of the fourth pull-down transistor 1234 receives the voltage signal CKB2. The second terminal of the fourth pull-down transistor 1234 receives the reference low voltage VGL.

For example, the pull-up circuit 122 pulls up the voltage value at the node P. Therefore, the output transistor 121 is turned on to output the gate drive signal SDG. The timing of the gate drive signal SDG is substantially the same as the timing of the clock signal CK3. Therefore, the generation time of the pulse of the gate drive signal SDG is substantially the same as the generation time of the pulse of the clock signal CK3.

The pull-down circuit 123 further includes a pull-down control circuit 1235. The pull-down control circuit 1235 controls the first pull-down transistor 1231, the second pull-down transistor 1232, the third pull-down transistor 1233, and the fourth pull-down transistor 1234 to perform the voltage pull-down operation.

In this embodiment, the pull-up circuit 122 includes a pull-up transistor 1221. The first terminal and the control terminal of the pull-up transistor 1221 receive the clock signal CK1. The second terminal of the pull-up transistor 1221 is electrically connected to the node P. The pull-up transistor 1221 is turned on according to the positive pulse of the clock signal CK1, thereby pulling up the voltage value at node P. The pull-up transistor 1221 is turned off according to the low voltage of the clock signal CK1. Therefore, the node P is floating. At this time, the output transistor 121 outputs the gate drive signal SDG based on the clock signal CK3. When the positive pulse of the gate drive signal SDG is generated, the capacitor C1 may further pull up the voltage value at the node P through capacitive coupling, thereby ensuring that the output transistor 121 is turned on.

For example, after the pulse of the gate drive signal SDG is generated, the pull-down control circuit 1235, for example, according to the clock signal CK2, electrically connects the first terminal of the first pull-down transistor 1231 and the first terminal of the second pull-down transistor 1232 to the node P, and electrically connects the first terminal of the third pull-down transistor 1233 and the first terminal of the fourth pull-down transistor 1234 to the second terminal of the output transistor 121. Therefore, the pull-down circuit 123 begins to operate. The first pull-down transistor 1231 pulls down the voltage value at the node P according to the high voltage V1 of the voltage signal CKB1. The second pull-down transistor 1232 pulls down the voltage value at node P according to the high voltage V1 of the voltage signal CKB2. The third pull-down transistor 1233 pulls down the voltage value at the second terminal of the output transistor 121 according to the high voltage V1 of the voltage signal CKB1. The fourth pull-down transistor 1234 pulls down the voltage value at the second terminal of the output transistor 121 according to the high voltage V1 of the voltage signal CKB2.

In this embodiment, the voltage signal CKB1 and the voltage signal CKB2 are inverted relative to each other. In the first time period T1, the first pull-down transistor 1231 is turned on according to the high voltage V1 of the voltage signal CKB1. The second pull-down transistor 1232 is turned off according to the low voltage V2 of the voltage signal CKB2. In the second time period T2, the first pull-down transistor 1231 is turned off according to the low voltage V2 of the voltage signal CKB1. The second pull-down transistor 1232 is turned on according to the high voltage V1 of the voltage signal CKB2. As may be seen, the first pull-down transistor 1231 and the second pull-down transistor 1232 are alternately turned on to pull down the voltage generated at the node P after the pulse of the gate drive signal SDG is generated. Therefore, the first pull-down transistor 1231 and the second pull-down transistor 1232 are turned on alternately, which allows them to rest in turn. Similarly, the third pull-down transistor 1233 and the fourth pull-down transistor 1234 are alternately turned on to pull down the voltage generated at the second terminal of the output transistor 121 after the positive pulse of the gate drive signal SDG is generated. Therefore, the third pull-down transistor 1233 and the fourth pull-down transistor 1234 are turned on alternately, which allows them to rest in turn. As a result, the service life of the gate driver circuit 120 can be improved.

In this embodiment, the output transistor 121, the first pull-down transistor 1231, the second pull-down transistor 1232, the third pull-down transistor 1233, the fourth pull-down transistor 1234, and the pull-up transistor 1221 may each be implemented by any type of N-type transistor. In some embodiments, the output transistor 121, the first pull-down transistor 1231, the second pull-down transistor 1232, the third pull-down transistor 1233, the fourth pull-down transistor 1234, and the pull-up transistor 1221 may each be implemented by any type of P-type transistor.

According to some embodiments, as shown in FIGS. 1 and 6, in the first time period T1, the voltage value of the voltage signal CKB1 is the high voltage V1. The first pull-down transistor 1231 and the third pull-down transistor 1233 are turned on. Therefore, the first pull-down transistor 1231 pulls down the voltage value at the control terminal (that is, the node P) of the output transistor 121 according to the voltage signal CKB1 located on the first signal line L1. The third pull-down transistor 1233 pulls down the voltage value at the second terminal of the output transistor 121 according to the voltage signal CKB1 located on the first signal line L1. In the first time period T1, the voltage value of the voltage signal CKB2 is the low voltage V2. The second pull-down transistor 1232 and the fourth pull-down transistor 1234 are turned off. In the second time period T2, the voltage value of the voltage signal CKB2 is the high voltage V1. The second pull-down transistor 1232 and the fourth pull-down transistor 1234 are turned on. Therefore, the second pull-down transistor 1232 pulls down the voltage value at the control terminal of the output transistor 121 according to the voltage signal CKB2 located on the second signal line L2. The fourth pull-down transistor 1234 pulls down the voltage value at the second terminal of the output transistor 121 according to the voltage signal CKB2 located on the second signal line L2. In the second time period T2, the voltage value of the voltage signal CKB1 is the low voltage V2. The first pull-down transistor 1231 and the third pull-down transistor 1233 are turned off. Based on the above, the first pull-down transistor 1231 and the second pull-down transistor 1232 in the gate driver unit GU are alternately turned on. The third pull-down transistor 1233 and the fourth pull-down transistor 1234 are alternately turned on. Therefore, after the positive pulse of the gate drive signal SDG is generated, the voltage value of the gate drive signal SDG is maintained at a low level.

In addition, as shown in FIG. 2, between the timing controller 231 and the level shifter 232, except for the line transmitting the frame start signal STV, no additional slow signal lines are needed. Slow signal lines are used for transmitting signals with frequencies lower than the clock signals CK1, CK2, CK3 and the frame frequency (such as the first signal CB1 and the second signal CB2 shown in FIG. 5). In this way, the overall area of the circuit board can be saved, and the cost is reduced.

In summary, the control element generates high voltage and low voltage according to the frame start signal. In the first time period, the control element provides the high voltage to the first signal line and provides the low voltage to the second signal line. In the second time period, the control element provides the high voltage to the second signal line and provides the low voltage to the first signal line. That is, the control element generates the first voltage signal and the second voltage signal according to the frame start signal. Compared with the related art, the control element disclosed in this disclosure does not need to receive the first signal and the second signal to generate the first voltage signal and the second voltage signal. The control element does not need two additional connection lines to transmit the first signal and the second signal, either. In this way, the area of the control element can be reduced.

Although the disclosure has been disclosed in the embodiments as above, the embodiments are not intended to limit the disclosure. Persons with ordinary knowledge in the relevant technical field may make some changes and modifications without departing from the spirit and scope of this disclosure. Therefore, the scope of protection of the disclosure shall be defined by the appended claims.

What is claimed is:

1. An electronic device, comprising:
a display panel, comprising:
a substrate;
a plurality of gate lines disposed on the substrate; and
a plurality of pixel units disposed on the substrate, wherein the plurality of gate lines are respectively electrically connected to the plurality of pixel units, and the display panel displays within a plurality of frame times;
a gate driver circuit electrically connected to at least one of the plurality of gate lines;
a control element configured to provide a plurality of frame start signals within the plurality of frame times;
a first signal line electrically connected between the control element and the gate driver circuit; and
a second signal line electrically connected between the control element and the gate driver circuit,
wherein in a first time period, the control element is configured to provide a first voltage to the first signal line and provide a second voltage to the second signal line, the first time period is greater than two of the frame times, and the first voltage is higher than the second voltage, and
in a second time period, the control element is configured to provide the first voltage to the second signal line and provide the second voltage to the first signal line, and the second time period is greater than two of the frame times.

2. The electronic device as claimed in claim 1, wherein the control element comprises:
a timing controller configured to provide the plurality of frame start signals; and
a level shifter electrically connected to the timing controller, wherein the level shifter is configured to receive the plurality of frame start signals and configured to provide the first voltage and the second voltage.

3. The electronic device as claimed in claim 2, wherein the level shifter is configured to generate the first voltage and the second voltage according to the frame start signals.

4. The electronic device as claimed in claim 2, wherein
in response to the electronic device being powered on, the electronic device generates a reference low voltage and a reference high voltage,
the level shifter generates the second voltage according to the reference low voltage, and
the level shifter generates the first voltage according to the reference high voltage.

5. The electronic device as claimed in claim 4, wherein the level shifter first generates the second voltage according to the reference low voltage, and then generates the first voltage according to the reference high voltage.

6. The electronic device as claimed in claim 2, wherein the level shifter comprises:
a counter configured to receive the frame start signals and count the number of the frame start signals to generate a count value, wherein
the control element comprises:
a storage unit configured to store a count setting value; and
a comparator unit configured to compare the count value and the count setting value, wherein in response to the count value matching the count setting value, the level shifter is configured to initiating a transition between the first time period and the second time period at a switching time point.

7. The electronic device as claimed in claim 6, wherein the frame times comprise a first frame time and a second frame time, the first frame time comprises a first display period and a first blanking period, the second frame time comprises a second display period and a second blanking period, the first blanking period is between the first display period and the second display period, the timing controller is configured to provide a blanking signal within the first blanking period, and the first blanking period comprises the switching time point.

8. The electronic device as claimed in claim 7, wherein
the storage unit is configured to store a time setting value, and
the level shifter comprises a timer configured to generate the switching time point based on a time point of start of pulse of the blanking signal plus the time setting value.

9. The electronic device as claimed in claim 7, wherein
the storage unit is configured to store a time setting value, and
the level shifter comprises a timer configured to generate the switching time point based on a time point of end of pulse of the blanking signal plus the time setting value.

10. The electronic device as claimed in claim 9, wherein the level shifter further comprises:
a signal generator coupled to the storage unit, and configured to receive the count value from the counter and a timer value from the timer, and to generate a first signal and a second signal based on the count value and the timer value,
wherein a voltage state of the first signal and a voltage state of the second signal are opposite to each other.

11. The electronic device as claimed in claim 10, wherein
the level shifter generates a first voltage signal based on the first signal, and generates a second voltage signal based on the second signal,
a voltage value of the first voltage signal in the first time period equals a voltage value of the first voltage, a voltage value of the first voltage signal in the second time period equals a voltage value of the second voltage, and
a voltage value of the second voltage signal in the first time period equals the voltage value of the second voltage, a voltage value of the second voltage signal in the second time period equals the voltage value of the first voltage.

12. The electronic device as claimed in claim 11, wherein the voltage state of the first voltage signal and the voltage state of the second voltage signal are switched at the switching time point.

13. The electronic device as claimed in claim 11, wherein the level shifter further comprises:
a first amplifier coupled to the signal generator, and configured to amplify the first signal to generate the first voltage signal; and
a second amplifier coupled to the signal generator, and configured to amplify the second signal to generate the second voltage signal.

14. The electronic device as claimed in claim 10, wherein the counter and the timer are disposed in the signal generator.

15. The electronic device as claimed in claim 1, wherein the gate driver circuit comprises:
an output transistor, wherein a first terminal of the output transistor receives a clock signal, a second terminal of the output transistor outputs a gate drive signal, and the at least one of the plurality of gate lines is configured to receive the gate drive signal;
a capacitor electrically connected between the second terminal of the output transistor and a control terminal of the output transistor;
a pull-up circuit electrically connected to the control terminal of the output transistor, and configured to pull up a voltage value at the control terminal of the output transistor;
a pull-down circuit electrically connected to the control terminal of the output transistor, wherein the pull-down circuit comprises:
a first pull-down transistor configured to pull down the voltage value at the control terminal of the output transistor according to a voltage signal at the first signal line; and
a second pull-down transistor configured to pull down the voltage value at the control terminal of the output transistor according to a voltage signal at the second signal line.

16. The electronic device as claimed in claim 15, wherein the pull-down circuit further comprises:
a third pull-down transistor configured to pull down a voltage value at the second terminal of the output transistor according to the voltage signal at the first signal line; and
a fourth pull-down transistor configured to pull down the voltage value at the second terminal of the output transistor according to the voltage signal at the second signal line.

17. The electronic device as claimed in claim 15, wherein
in the first time period, the first pull-down transistor is configured to pull down the voltage value at the control terminal of the output transistor according to the voltage signal at the first signal line, and
in the second time period, the second pull-down transistor is configured to pull down the voltage value at the control terminal of the output transistor according to the voltage signal at the second signal line.

18. The electronic device as claimed in claim 1, wherein the gate driver circuit is disposed on the substrate.

19. The electronic device as claimed in claim 1, wherein the gate driver circuit is disposed outside the substrate.

20. The electronic device as claimed in claim 1, wherein a time duration of the first time period and a time duration of the second time period are respectively greater than two of the frame times and less than or equal to 1000 of the frame times.
